(19) United States
(12) Patent Application Publication
(10) Pub. No.: US 2023/0385562 A1
(43) Pub. Date: Nov. 30, 2023

(54) DATA PROCESSING SYSTEM, OPERATING METHOD OF THE DATA PROCESSING SYSTEM, AND COMPUTING SYSTEM USING THE DATA PROCESSING SYSTEM AND OPERATING METHOD OF THE DATA PROCESSING SYSTEM

(71) Applicant: SK hynix Inc., Icheon-si Gyeonggi-do (KR)

(72) Inventor: Seok Min LEE, Icheon-si Gyeonggi-do (KR)

(73) Assignee: SK hynix Inc., Icheon-si Gyeonggi-do (KR)

(21) Appl. No.: 18/077,932

(22) Filed: Dec. 8, 2022

(30) Foreign Application Priority Data
May 24, 2022 (KR) 10-2022-0063479

(51) Int. Cl. G06J 1/00

(52) U.S. Cl. CPC G06J 1/00

(57) ABSTRACT

A data processing system may include a processing memory including a plurality of sub-arrays, and a controller that controls the processing memory, detects a valid component from a first operand received from an exterior and having a digital level, applies a voltage corresponding to the valid component having a digital level to a row line of at least one sub-array, and stores a second operand received from an exterior in the at least one sub-array.

### CROSS-REFERENCES TO RELATED APPLICATION

The present application claims priority under 35 U.S.C. § 119(a) to Korean application number 10-2022-0063479, filed on May 24, 2022, in the Korean Intellectual Property Office, which is incorporated herein by reference in its entirety.

### BACKGROUND

### 1. Technical Field

The present technology relates to a data processing technology, and more particularly, to a data processing system, an operating method of the data processing system, and a computing system using the data processing system and the operating method of the data processing system.

### 2. Related Art

As the interest and importance of artificial intelligence applications and big data analysis increase, there is an increasing demand for a computing system capable of efficiently processing large-capacity data.

With an increase in the capacity of memory devices and the improvement of computing speed, in-memory computing technology for not only storing data but also performing data operation in the memory has emerged.

The in-memory computing technology is attracting attention as a technology for processing artificial intelligence applications, and various methods for more accurately processing data at high speed are being studied.

### SUMMARY

A data processing system according to an embodiment of the present technology may include: a processing memory including a plurality of sub-arrays, wherein each of the sub-arrays from the plurality of sub-arrays each include a plurality of memory cells connected between a plurality of row lines and a plurality of column lines; and a controller configured to control the processing memory, to detect a valid component from a first operand received from an exterior and having a digital level, to apply a voltage corresponding to the valid component having a digital level to a row line of at least one sub-array, and to store a second operand received from an exterior in the at least one sub-array.

An operating method of a data processing system according to an embodiment of the present technology may include: providing a processing memory including at least one sub-array including a plurality of memory cells connected between a plurality of row lines and a plurality of column lines; receiving, with a controller for controlling the processing memory, a first operand and a second operand each having a digital level from an exterior of the controller; detecting, with the controller, a valid component from the first operand; and applying, with the controller, a voltage corresponding to the valid component to a row line of at least one sub-array and storing, with the controller, the second operand in the at least one sub-array.

A computing system according to an embodiment of the present technology may include: a processing memory included in a data processing system that is configured to process an application operation in response to a request from the external device and the processing memory including a plurality of sub-arrays, wherein each of the sub-arrays from the plurality of sub-arrays includes a plurality of memory cells connected between a plurality of row lines and a plurality of column lines; and a controller configured to control the processing memory, to detect a valid component from a first operand received from an exterior and having a digital level, to apply a voltage corresponding to the valid component having a digital level to a row line of at least one sub-array, and to store a second operand received from an exterior in the at least one sub-array.

### BRIEF DESCRIPTION OF THE DRAWINGS

FIG. 1 is a configuration diagram of a computing system according to an embodiment.

FIG. 2 is a configuration diagram of a neural network processor according to an embodiment.

FIG. 3 is a configuration diagram of a processing memory according to an embodiment.

FIG. 4 is a conceptual diagram for explaining an in-memory embedding operation process according to an embodiment.

FIG. 5 is a conceptual diagram for explaining an in-memory embedding operation process according to an embodiment.

FIG. 6 is a conceptual diagram for explaining an in-memory embedding operation process according to an embodiment.

FIG. 7 is a flowchart for explaining an operating method of a data processing system according to an embodiment.

FIG. 8 is a flowchart for explaining an operating method of the data processing system according to an embodiment.

### DETAILED DESCRIPTION

Hereinafter, embodiments of the present technology will be described in more detail with reference to the accompanying drawings.

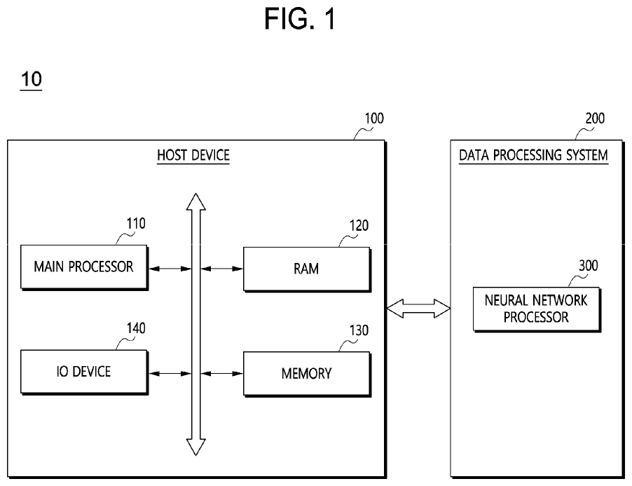

FIG. 1 is a configuration diagram of a computing system according to an embodiment.

Referring to FIG. 1, the computing system 10 according to an embodiment may include a host device 100 and a data processing system 200. The data processing system 200 may include a neural network processor 300 that processes an application operation in response to a request from the host device 100.

The host device 100 may include at least a main processor 110, a RAM 120, a memory 130, and an input/output (IO) device 140, and may further include other general-purpose components (not illustrated).

In an embodiment, the components of the host device 100 may be implemented as a system-on chip (SoC) integrated into one semiconductor chip; however, the present technology is not limited thereto and the components of the host device 100 may also be implemented as a plurality of semiconductor chips.

The main processor 110 may control the overall operation of the computing system 10, and may be, for example, a central processing unit (CPU). The main processor 110 may include one core or a plurality of cores. The main processor 110 may process or execute programs, data, and/or instructions stored in the RAM 120 and the memory 130. For example, the main processor 110 may control the functions of the computing system 10 by executing the programs stored in the memory 130.

The RAM 120 may store the programs, the data, or the instructions. The programs and/or the data stored in the memory 130 may be loaded into the RAM 120 according to the control or booting code of the main processor 110. The RAM 120 may be implemented using a memory such as a dynamic RAM (DRAM) or a static RAM (SRAM).

The memory 130 is a storage space for storing data, and may store, for example, an operating system (OS), various programs, and various data. The memory 130 may include at least one of a volatile memory and a nonvolatile memory. The nonvolatile memory may be selected from a read only memory (ROM), a programmable ROM (PROM), an electrically programmable ROM (EPROM), an electrically erasable and programmable ROM (EEPROM), a flash memory, a phase-change RAM (PRAM), a magnetic RAM (MRAM), a resistive RAM (RRAM), a ferroelectric RAM (FRAM), and the like. The volatile memory may be selected from a dynamic RAM (DRAM), a static RAM (SRAM), a synchronous DRAM (DRAM), and the like. Furthermore, in an embodiment, the memory 130 may be implemented as a storage device such as a hard disk drive (HDD), a solid-state drive (SSD), a compact flash (CF), a secure digital (SD), a micro-secure digital (micro-SD), a mini-secure digital (mini-SD), an extreme digital (xD), or a memory stick.

The IO device 140 may receive user input or external input data, and output a processing result of the computing system 10. The IO device 140 may be implemented as a touch screen panel, a keyboard, various types of sensors, and the like. In an embodiment, the IO device 140 may collect information around the computing system 10. For example, the IO device 140 may include an imaging device and an image sensor, sense or receive an image signal from the outside of the data processing system 200, convert the sensed or received image signal into image data, and store the image data in the memory 130 or provide the image data to the data processing system 200.

The data processing system 200 may process an application operation in response to a request from the outside, for example, the host device 100. Particularly, the data processing system 200 may analyze input data on the basis of an artificial neural network to extract valid information, and determine a situation on the basis of the extracted information or control the configurations of an electronic device provided with the data processing system 200. For example, the data processing system 200 may be applied to a drone, an advanced driver assistance system (ADAS), a smart TV, a smart phone, a medical device, a mobile device, a video display device, a measurement device, an Internet of Things (IoT) device, and the like, and may also be mounted on one of various types of computing systems 10.

In an embodiment, the host device 100 may offload a neural network operation onto the data processing system 200, and provide the data processing system 200 with initial parameters for the neural network operation, for example, an input matrix or an input vector, and a weight matrix. The input matrix may be referred to as an input feature map.

In an embodiment, the data processing system 200 may be an application processor mounted on a mobile device.

The data processing system 200 may include at least the neural network processor 300.

The neural network processor 300 may generate a neural network model by training or learning input data. The neural network processor 300 may generate an information signal by inferring the input data according to the neural network model, or retrain the neural network model. Examples of the neural network may include various types of neural network models such as a convolution neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network, a deep brief network (DBN), a restricted Boltzmann machine (RBM), a fully convolutional network, a long short-term memory (LSTM) network, and a classification network; however, the present technology is not limited thereto.

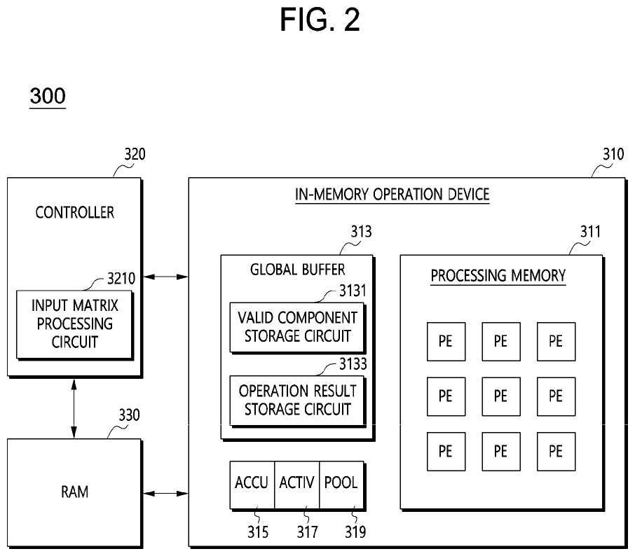

FIG. 2 is a configuration diagram of the neutral network processor 300 in accordance with an embodiment.

The neural network processor 300 may be a processor or an accelerator specialized for a neural network operation. As illustrated in FIG. 2, the neutral network processor 300 may include an in-memory operation device 310, a controller 320, and a RAM 330. In an embodiment, the neural network processor 300 may be implemented as a system-on chip (SoC) integrated into one semiconductor chip; however, the present technology is not limited thereto and the neural network processor 300 may also be implemented as a plurality of semiconductor chips.

The controller 320 may control the overall operation of the neural network processor 300. The controller 320 may set and manage parameters related to a neural network operation so that the in-memory operation device 310 may normally perform the neural network operation. The controller 320 may be implemented in the form of a combination of hardware and software (or firmware) or software executed on the hardware.

The controller 320 may be implemented as at least one processor, for example, a central processing unit (CPU), a microprocessor, or the like, and may execute instructions that are stored in the RAM 330 and constitute various functions.

As the host device 100 offloads the neural network operation by transmitting first operands and second operands as initial parameters to the neural network processor 300, the controller 320 may transmit an operand and an address of the in-memory operation device 310, to which the operand is to be provided, to the in-memory operation device 310. In an embodiment, the first operand may be an input matrix or an input vector and the second operand may be a weight matrix; however, the present technology is not limited thereto.

The RAM 330 may be implemented as a DRAM, an SRAM, or the like, and may store various programs and data for the operation of the controller 320 and data generated by the controller 320.

The in-memory operation device 310 may be configured to perform the neural network operation under the control of the controller 320. The in-memory operation device 310 may include a processing (computing) memory 311, a global buffer 313, an accumulator (ACCU) 315, an activator (ACTIV) 317, and a pooler (POOL) 319.

The processing memory 311 may include a plurality of processing elements PE. Each PE may receive operands from the global buffer 313 and perform an operation. In an embodiment, the operation performed by the PE may include an element-wise summation operation of the first operands and the second operands. In addition to this, the PE may perform a vector-matrix multiplication (VMM) operation.

In an embodiment, the operation performed by the PE may be an embedding operation including an element-wise summation operation between an embedding matrix serving as the first operand and a weight matrix serving as the second operand.

Embedding refers to a result or a process of converting non-numeric data such as natural language into numerical vectors that can be understood by machines. The embedding operation may be a process of generating a low-dimensional embedding vector by applying a weight matrix to an embedding matrix that is a high-dimensional sparse matrix. In an embodiment, the embedding matrix may be a result of encoding, in a set manner, input data to be learned or inferred. One example of the encoding method may include one-hot encoding, but is not limited thereto.

Each PE may include a plurality of sub-arrays. Each sub-array may include a plurality of memory cells connected between a plurality of row lines and a plurality of column lines. As the weight matrix serving as the second operand is stored in a memory cell of the sub-array, and the input matrix serving as the first operand is applied to a row line of the sub-array, an in-memory operation, for example, an embedding operation, may be performed.

In an embodiment, the sub-array may be a crossbar array of memory elements including memristor elements. The sub-array may be programmed so that a memristor memory cell disposed at an intersection of the crossbar array has conductance corresponding to an element value of the weight matrix (second operand), and each element of the input vector (the first operand) may be applied to the row line. An input voltage applied to each row line of the crossbar array and corresponding to each element of the input matrix is weighted by the conductance of the memristor memory cell, and a current value is accumulated for each column line and output.

The global buffer 313 may store operands and provide the operands to the processing memory 311, or may receive and store an operation result from the processing memory 311. The global buffer 313 may be implemented by DRAM, SRAM, or the like.

The ACCU 315 may be configured to derive a weighted sum by accumulating processing results of the PEs.

The ACTIV 317 may be configured to add nonlinearity by applying the weighted sum result of the ACCU 315 to an activation function such as ReLU.

The POOL 319 samples an output value of the ACTIV 317, and reduces and optimizes a dimension.

The data processing process through the in-memory operation device 310 may be a process of training or re-training a neural network model from input data, or a process of inferring the input data.

The controller 320 according to an embodiment of the present technology may include an input matrix processing circuit 3210.

The input matrix processing circuit 3210 may be configured to detect valid components from the first operands. In an embodiment, the first operand may be a sparse matrix or an embedding matrix in which each element has a first logic level, for example, “1” or a second logic level, for example, “0”. The input matrix processing circuit 3210 may detect a row including an element having the first logic level from the first operand as a valid component, and provide the detected row to the in-memory operation device 310 together with an address, to which the valid component in the in-memory operation device 310 is to be provided, for example, a row line address of the sub-array.

The input matrix processing circuit 3210 may group the first operands and the second operands into a plurality of groups, for example, a first number of groups, according to the address of the in-memory operation device 310 to which the first operands and the second operands are to be provided. The first number may be set at the time of manufacturing the neural network processor 300 or the data processing system 200 provided with the neural network processor 300, and may be changed by a user.

The grouped first and second operands may be provided to the first number of sub-arrays, respectively. In an embodiment, the input matrix processing circuit 3210 may group the first and second operands on the basis of the row line address of the sub-array. That is, the first and second operands may be grouped in units of a plurality of rows. Accordingly, neural network operations may be distributed and processed in parallel in a plurality of sub-arrays.

The number of row lines in the sub-array increases, resulting in a phenomenon in which a read voltage applied to the row lines of the sub-array drops. When the neural network operation is performed by applying all input vectors to a single sub-array, the read voltage drop phenomenon is aggravated, but the voltage drop phenomenon for each sub-array may be minimized by operating the first and second operands in a plurality of sub-arrays in a distributed manner.

In an embodiment, the global buffer 313 may include a valid component storage circuit 3131 and an operation result storage circuit 3133. The valid component storage circuit 3131 may store the valid components of the first operands and the second operands transmitted from the input matrix processing circuit 3210. The operation result storage circuit 3133 may receive and store the operation result of the processing memory 311.

The elements constituting the second operand stored in the valid component storage circuit 3131 may be stored (programmed) in memory cells in the sub-array corresponding to an address provided from the controller 320. A first input voltage having a preset level corresponding to the valid component of the first operand stored in the valid component storage circuit 3131 may be applied to a row line in the sub-array corresponding to the address provided from the controller 320. An input voltage corresponding to an invalid component that is a remaining component other than the valid component of the first operand may be applied to the row line in the sub-array corresponding to the address provided from the controller 320. The word “preset” as used herein with respect to a parameter, such as a preset level, means that a value for the parameter is determined prior to the parameter being used in a process or algorithm. For some embodiments, the value for the parameter is determined before the process or algorithm begins. In other embodiments, the value for the parameter is determined during the process or algorithm but before the parameter is used in the process or algorithm.

Each element of the embedding matrix is a sparse matrix having a first logic level or a second logic level. In an embodiment, the valid component of the first operand buffered in the valid component storage circuit 3131 of the global buffer 313 may be position information (row number) of an element having a logic high level in the embedding matrix. Since an invalid component, which is an element having a logic low level in the embedding matrix, is a component excluding the valid component from the embedding matrix having a set size, the invalid component may not be stored in the global buffer 313. The controller 320 may provide the in-memory operation device 310 with row line addresses to which the input matrix is to be applied and an address (row number) to which the valid component is to be applied among the row line addresses, thereby applying a voltage corresponding to each element of the input matrix to a corresponding row line of the sub-array.

Since the first operand, which is the input matrix, is provided at a digital level, a voltage corresponding to an element having a digital level may be applied to the row line of the sub-array before the first operand is applied to the sub-array without a process of converting the elements of the first operand into a digital signal.

When the input matrix processing circuit 3210 groups the first and second operands into a plurality of groups and controls the grouped first and second operands to be distributed and operated in the plurality of sub-arrays, the operation result storage circuit 3133 may store partial operation results output from each of the plurality of sub-arrays. The partial operation results stored in the operation result storage circuit 3133 may be summed by the ACCU 315, the summed partial operation results may be derived as a final operation result, and then the final operation result may be stored in the operation result storage circuit 3133.

Each sub-array may output an element-wise summation result having an analog level, and the element-wise summation result may be digitized by an analog-to-digital converter and the digitized result having an analog level, and the element may be stored in the operation result storage circuit 3133. In an embodiment, the analog-to-digital converter may be connected to each sub-array or may be connected in common to the plurality of sub-arrays.

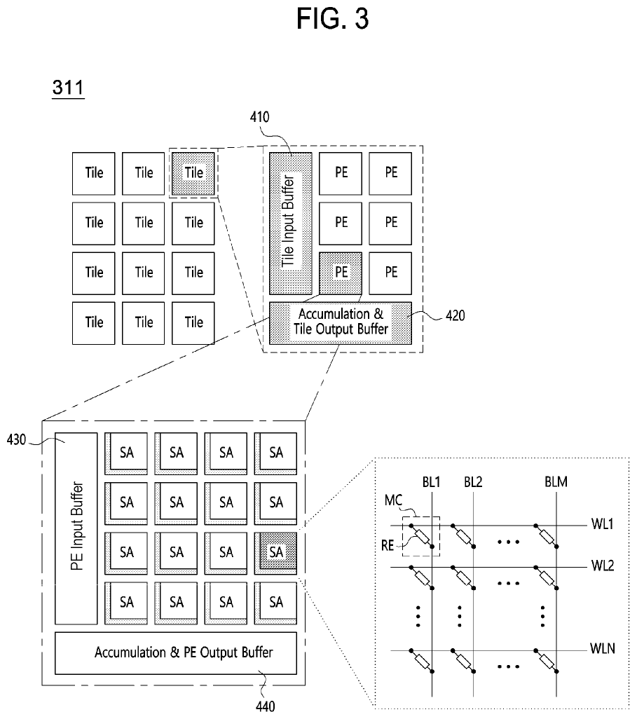

FIG. 3 is a configuration diagram of the processing memory 311 according to an embodiment.

Referring to FIG. 3, the processing memory 311 according to an embodiment may be divided into a plurality of tiles.

Each tile may include a tile input buffer Tile Input Buffer 410, the plurality of processing elements PE, and an accumulation and tile output buffer Accumulation & Tile Output Buffer 420.

Each PE may include a PE input buffer PE Input Buffer 430, a plurality of sub-arrays SA, and an accumulation and PE output buffer Accumulation & PE Output Buffer 440.

The SA may be referred to as a synapse array, and includes a plurality of word lines WL1 to WLN, a plurality of bit lines BL1 to BLM, and a plurality of memory cells MC. The word lines WL1 to WLN may be referred to as row lines and the bit lines BL1 to BLM may be referred to as column lines. In an embodiment, the memory cells MC may include a resistive memory element RE, preferably, a memristor element; however, the present technology is not limited thereto. Conductance, that is, a data value stored in the memory cell MC may be changed by a write voltage applied through the plurality of word lines WL1 to WLN or the plurality of bit lines BL1 to BLM, and resistive memory cells may store data by such a change in resistance.

In an embodiment, each resistive memory cell may be implemented by including a resistive memory cell such as a phase change random access memory (PRAM) cell, a resistive random access memory (RRAM) cell, a magnetic random access memory (MRAM) cell, and a ferroelectric random access memory (FRAM) cell.

A resistive element constituting the resistive memory cell may also include a phase-change material. The phase-change material may have crystal state changes according to the amount of current, perovskite compounds, a transition metal oxide, magnetic materials, ferromagnetic materials, or antiferromagnetic materials; however, the present technology is not limited thereto.

When a unit cell of the SA is configured as a memristor element, the PE may store data corresponding to each element of the weight matrix in the memristor element, apply voltages corresponding to each element of the input matrix to the word lines WL1 to WLN, and perform an in-memory operation by using Kirchhoff's law and Ohm's law.

Each of the bit lines BL1 to BLM may be referred to as an output channel.

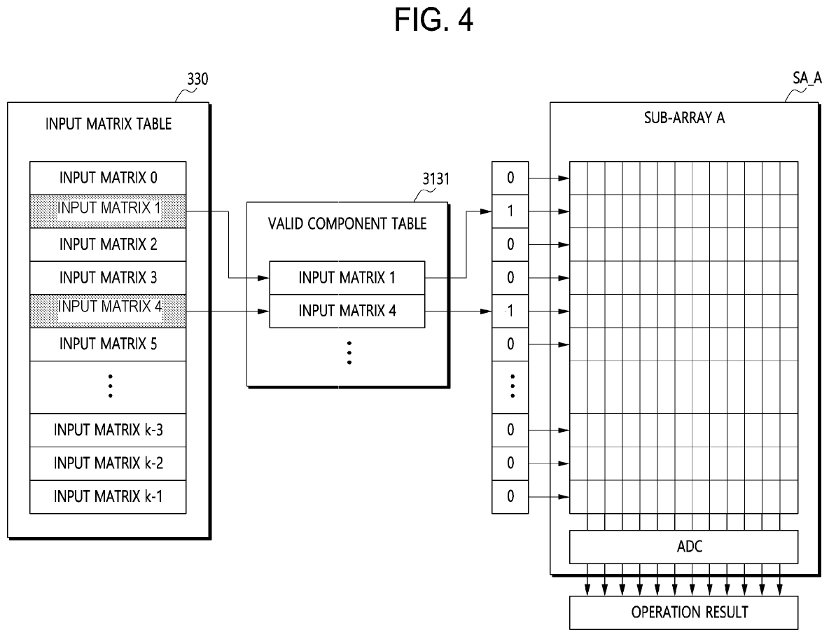

Each of the sub-arrays SA may include an analog-to-digital converter connected to one end of each of the bit lines BL1 to BLM, which will be described with reference to FIG. 4.

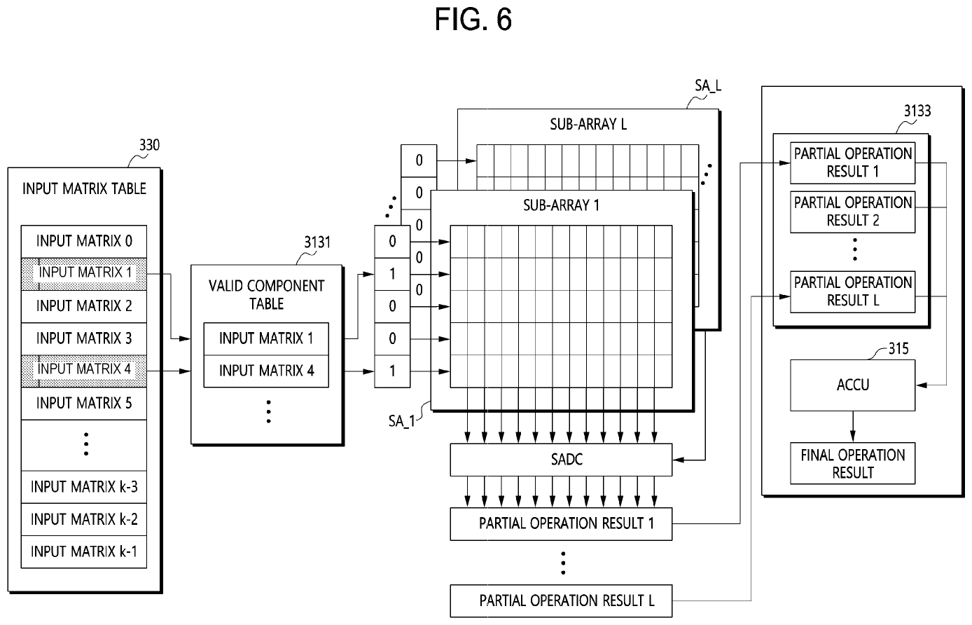

In another embodiment, a set number of sub-arrays SA may share one analog-to-digital converter, which will be described with reference to FIG. 6.

FIG. 4 is a conceptual diagram for explaining an in-memory embedding operation process according to an embodiment.

An input matrix of K-rows provided from the outside may be stored, as an input matrix table, in the RAM 330 of the neural network processor 300 that may be included in the data processing system 200.

The input matrix processing circuit 3210 of the controller 320 may detect valid components (input matrices of 1 row and 4 row) by referring to the input matrix table. The valid components may be stored as a valid component table in the valid component storage circuit 3131 of the in-memory operation device 310.

The controller 320 may designate a sub-array A (SA_A) as a position where an in-memory operation is to be performed, and transmit the first and second operands and a row line address and a column line address, to which the first and second operands are applied, to the in-memory operation device 310.

Accordingly, the memristor memory cell of the sub-array A (SA_A) may be programmed to have conductance corresponding to the element value of the second operand, and an input voltage corresponding to each element of the first operand may be applied to the row line. Particularly, in the present technology, on the basis of the row number of the valid component stored in the valid component storage circuit 3131, a first input voltage having a preset level may be applied to a row line corresponding to the valid component, and a second input voltage having a preset level may be applied to the other row lines. The first and second input voltages applied to the respective row lines are weighted by the conductance of the memristor memory cell, and a current value is accumulated for each column line. As the analog-to-digital converter (ADC) connected to one end of the column line converts an accumulated current value for each column line into a digital value, a final operation result may be output from the sub-array A (SA_A).

The final operation result of the sub-array A (SA_A) may be stored in the operation result storage circuit 3133. The final operation result of the operation result storage circuit 3133 may be re-input to the processing memory 311 or output to the outside.

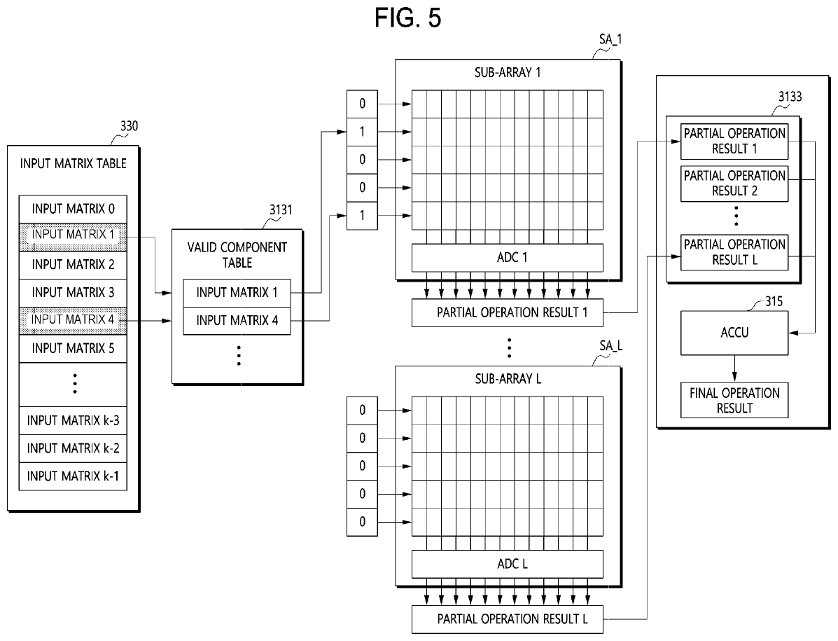

FIG. 5 is a conceptual diagram for explaining an in-memory embedding operation process according to an embodiment.

An input matrix of K-rows provided from the outside may be stored, as an input matrix table, in the RAM 330 of the neural network processor 300 that may be included in the data processing system 200.

The input matrix processing circuit 3210 of the controller 320 may detect valid components (input matrices of 1 row and 4 row) by referring to the input matrix table. The valid components may be stored as a valid component table in the valid component storage circuit 3131 of the in-memory operation device 310.

The input matrix processing circuit 3210 of the controller 320 may group the first and second operands on the basis of a row line address of a sub-array to which the first operand and the second operand are to be provided, that is, in units of a plurality of rows.

When the controller 320 designates L sub-arrays SA_1 to SA_L as positions where an in-memory operation is to be performed, the first and second operands may be grouped into L groups, respectively. In such a case, each of the grouped first and second operands may include K/L elements.

The controller 320 may transmit, to the in-memory operation device 310, the grouped first and second operands, and the row line address and the column line address of each of the plurality of sub-arrays SA_1 to SA_L to which the grouped first and second operands are to be applied.

Accordingly, the memristor memory cells of each sub-array A (SA_1 to SA_L) may be programmed to have conductance corresponding to element values of a corresponding second operand group, and an input voltage corresponding to each element of the first operand group may be applied to a row line. Particularly, in the present technology, on the basis of the row number of a valid component stored in the valid component storage circuit 3131, a first input voltage may be applied to a row line corresponding to the valid component, and a second input voltage may be applied to the other row lines. The first and second input voltages applied to the respective row lines are weighted by the conductance of the memristor memory cell, and a current value is accumulated for each column line. As each of the analog-to-digital converters ADC 1 to ADC L connected to one ends of the column lines of the sub arrays SA_1 to SA_L converts the accumulated current value for each column line into a digital value, a partial operation result may be output from each of the sub-arrays SA_1 to SA_L.

The partial operation results may be stored in the operation result storage circuit 3133, the stored partial operation results may be summed by the ACCU 315, and then the summed partial operation results may be derived as a final operation result.

The final operation result may be stored in the operation result storage circuit 3133. The final operation result of the operation result storage circuit 3133 may be re-input to the processing memory 311 or output to the outside.

FIG. 6 is a conceptual diagram for explaining an in-memory embedding operation process according to an embodiment

FIG. 6 illustrates an example in which a set number of sub-arrays SA_1 to SA_L share one analog-to-digital converter SADC.

First and second operands grouped in a similar manner to that described with reference to FIG. 5 may be provided to the plurality of sub-arrays SA_1 to SA_L, and a current value may be summed for each column line in each of the sub-arrays SA_1 to SA_L.

The column lines of each of the sub-arrays SA_1 to SA_L may be connected to a shared ADC (SADC) in a set order, and the shared ADC (SADC) may convert a partial operation result for each of the sub-arrays SA_1 to SA_L into a digital value and store the digital value in the operation result storage circuit 3133. The partial operation results stored in the operation result storage circuit 3133 may be summed by the ACCU 315 and the summed partial operation results may be derived as a final operation result.

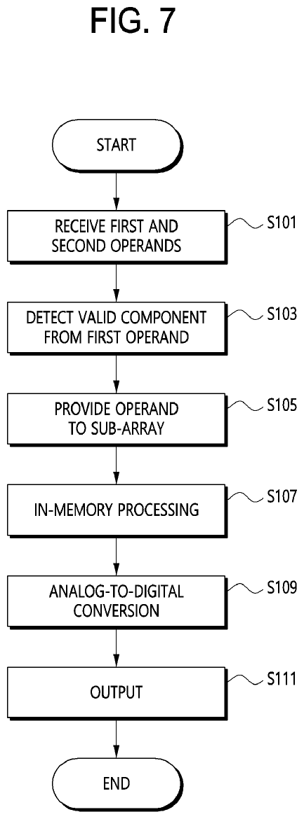

FIG. 7 is a flowchart for explaining an operating method of the data processing system 200 according to an embodiment.

The first operands and the second operands provided from the outside may be stored in the RAM 330 of the neural network processor 300 that may be included in the data processing system 200 (S101). The first operand may be an input matrix and the second operand may be a weight matrix.

The controller 320 may detect valid components from the first operands stored in the RAM 330 (S103).

The controller 320 may provide the valid components of the first operands and the second operand to at least one sub-array in the in-memory operation device 310 (S105).

Specifically, the memristor memory cell of the sub-array designated by the controller 320 may be programmed to have conductance corresponding to an element value of the second operand. A first input voltage may be applied to a row line corresponding to the valid component among elements of the first operand, and a second input voltage may be applied to the other row lines.

The first and second input voltages applied to each row line may be weighted by the conductance of the memristor memory cell, and a current value may be accumulated for each column line, so that an in-memory processing may be performed (S107).

The current value accumulated for each column line may be converted into a digital value by an analog-to-digital converter (ADC) connected to one end of the column line (S109), and a final operation result may be output (S111).

The final operation result of the sub-array may be stored in the global buffer 313 and then reused for an in-memory operation or output to the outside, for example, the host device 100, the controller 320 or the RAM 330.

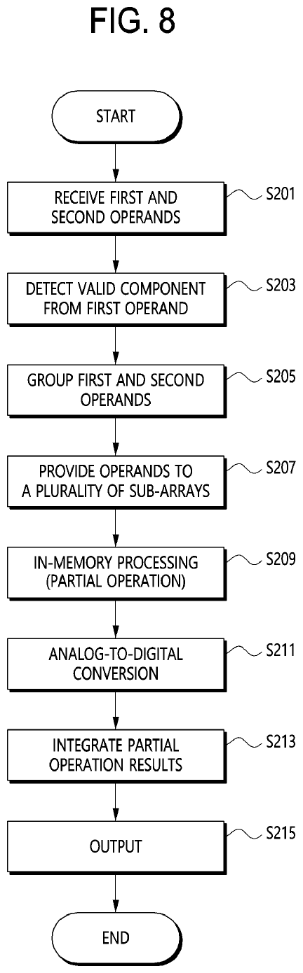

FIG. 8 is a flowchart for explaining an operating method of the data processing system 200 according to an embodiment.

The first operands and the second operands provided from the outside may be stored in the RAM 330 of the neural network processor 300 that may be included in the data processing system 200 (S201). The first operand may be an input matrix and the second operand may be a weight matrix.

The controller 320 may detect valid components from the first operands stored in the RAM 330 (S203).

The controller 320 may group the first and second operands into a first number of groups on the basis of a row line address of a sub-array to which the first operand and the second operand are to be provided, that is, in units of a plurality of rows (S205).

The controller 320 may provide the valid components of the grouped first operands and the grouped second operands to the first number of sub-arrays in the in-memory operation device 310 (S207).

Specifically, the memristor memory cell of each of the first number of sub-arrays designated by the controller 320 may be programmed to have conductance corresponding to an element value of a corresponding second operand group. A first input voltage may be applied to a row line corresponding to the valid component among elements of the first operand group, and a second input voltage may be applied to the other row lines.

The first and second input voltages applied to the respective row lines may be weighted by the conductance of the memristor memory cell, a current value may be accumulated for each column line, and an in-memory processing may be performed, so that a partial operation result may be derived for each of the first number of sub-arrays (S209).

The partial operation result that is a current value accumulated for each column line of each of the first number of sub-arrays is converted into a digital value by an analog-to-digital converter (ADC) (S211). In an embodiment, each of the plurality of sub-arrays may include the analog-to-digital converter (ADC), so that the partial operation result may be digitized for each sub-array. In an embodiment, the plurality of sub-arrays may share a single analog-to-digital converter (ADC), so that a partial operation result of each of the plurality of sub-arrays may be sequentially digitized by the shared analog-to-digital converter (ADC).

The digitized partial operation results may be summed by the ACCU 315 and the summed partial operation results may be output as a final operation result (S213). The final operation result may be stored in the global buffer 313 and then reused for an in-memory operation or output to the outside (S215).

In addition, in an embodiment, a plurality of sub-arrays operate operands in a distributed manner, so that noise and power consumption generated in the sub-arrays may be minimized, which makes it possible to perform an efficient neural network operation.

A person skilled in the art to which the present disclosure pertains can understand that the present disclosure may be carried out in other specific forms without changing its technical spirit or essential features. Therefore, it should be understood that the embodiments described above are illustrative in all respects, not limitative. The scope of the present disclosure is defined by the claims to be described below rather than the detailed description, and it should be construed that the meaning and scope of the claims and all modifications or modified forms derived from the equivalent concept thereof are included in the scope of the present disclosure.

What is claimed is:

1. A data processing system comprising:
a processing memory including a plurality of sub-arrays, wherein each of the sub-arrays from the plurality of sub-arrays each include a plurality of memory cells connected between a plurality of row lines and a plurality of column lines; and
a controller configured to control the processing memory, to detect a valid component from a first operand received from an exterior and having a digital level, to apply a voltage corresponding to the valid component having a digital level to a row line of at least one sub-array, and to store a second operand received from an exterior in the at least one sub-array.

2. The data processing system according to claim 1, wherein the processing memory is configured to perform an element-wise summation operation on the first operand and the second operand.

3. The data processing system according to claim 1, further comprising:
an analog-to-digital converter connected to each of the plurality of sub-arrays; and
an accumulator configured to sum output signals of the analog-to-digital converter.

4. The data processing system according to claim 1, wherein the first operand and the second operand are each configured as a matrix, and the controller is configured to group the first operand and the second operand in units of a first number of rows and to provide the grouped first operand and second operand to the first number of sub-arrays, respectively.

5. The data processing system according to claim 4, further comprising:
a shared analog-to-digital converter connected in common to the column line of each of the plurality of sub-arrays; and
an accumulator configured to sum output signals of the shared analog-to-digital converter.

6. The data processing system according to claim 1, wherein each of the plurality of memory cells includes a memristor element.

7. The data processing system according to claim 1, wherein the first operand includes an embedding matrix and the second operand includes a weight matrix.

8. An operating method of a data processing system, the operating method comprising:
providing a processing memory including at least one sub-array including a plurality of memory cells connected between a plurality of row lines and a plurality of column lines;
receiving, with a controller for controlling the processing memory, a first operand and a second operand each having a digital level from an exterior of the controller;
detecting, with the controller, a valid component from the first operand; and
applying, with the controller, a voltage corresponding to the valid component to a row line of at least one sub-array and storing, with the controller, the second operand in the at least one sub-array.

9. The operating method according to claim 8, further comprising:
performing, with the processing memory, an element-wise summation operation on the first operand and the second operand.

10. The operating method according to claim 9, further comprising:
converting summation operation results of the at least one sub-array into digital values.

11. The operating method according to claim 10, further comprising:
summing the digital values.

12. The operating method according to claim 8, wherein the first operand and the second operand are each configured as a matrix, and
the operating method further comprises:
grouping, with the controller, the externally provided first operand and second operand in units of a first number of rows and providing, with the controller, the grouped first operand and second operand to the first number of sub-arrays, respectively.

13. The operating method according to claim 8, wherein the first operand includes an embedding matrix and the second operand includes a weight matrix.

14. A computing system comprising:
an external device;
a processing memory included in a data processing system that is configured to process an application operation in response to a request from the external device and the processing memory including a plurality of sub-arrays, wherein each of the sub-arrays from the plurality of sub-arrays includes a plurality of memory cells connected between a plurality of row lines and a plurality of column lines; and
a controller configured to control the processing memory, to detect a valid component from a first operand received from an exterior and having a digital level, to apply a voltage corresponding to the valid component having a digital level to a row line of at least one sub-array, and to store a second operand received from an exterior in the at least one sub-array.

15. The computing system according to claim 14, wherein the processing memory is configured to perform an element-wise summation operation on the first operand and the second operand.

16. The computing system according to claim 14, further comprising:
an analog-to-digital converter connected to each of the plurality of sub-arrays; and
an accumulator configured to sum output signals of the analog-to-digital converter.

17. The computing system according to claim 14, wherein the first operand and the second operand are each configured as a matrix, and the controller is configured to group the first operand and the second operand in units of a first number of rows and to provide the grouped first operand and second operand to the first number of sub-arrays, respectively.

18. The computing system according to claim 17, further comprising:
a shared analog-to-digital converter connected in common to the column line of each of the plurality of sub-arrays; and
an accumulator configured to sum output signals of the shared analog-to-digital converter.

19. The computing system according to claim 14, wherein each of the plurality of memory cells includes a memristor element.

20. The computing system according to claim 14, wherein the first operand includes an embedding matrix and the second operand includes a weight matrix.
